(19) United States
(12) Patent Application Publication
(10) Pub. No.: US 2008/0077868 A1
(43) Pub. Date: Mar. 27, 2008

(54) System and Method for Visually Representing Resource Usage in a Multi-Node Data Processing System

(76) Inventors: Francis M. Bartucca, Raleigh, NC (US); Billy R. Robinson, Coppell, TX (US); Punit B. Shah, Portland, OR (US); Carlos P. Sosa, Eagan, MN (US)

Correspondence Address: DILLON & YUDELL LLP, 8911 N. CAPITAL OF TEXAS HWY.,, SUITE 2110, AUSTIN, TX, 78759, US

(21) Appl. No.: 11/534,422

(22) Filed: Sep. 22, 2006

(51) Int. Cl. G06F 9/00

(52) U.S. Cl. 715/736; 715/735

(57) ABSTRACT

A method, system, and computer-usable medium for visually representing resource usage in a multi-node data processing system. According to a preferred embodiment of the present invention a graphical user interface (GUI) stored in system memory visually expresses the multi-node data processing system as a collection of cubes, where each cube among the collection of cubes represents at least one node within the multi-node data processing system. The GUI specifies a currently-running application to measure a level of resources utilized by the currently-running application. The GUI indicates a type of resource information to be displayed and display the indicated type of resource information related to the currently-running application utilizing the collection of cubes.

### BACKGROUND OF THE INVENTION

1. Technical Field

The present invention relates in general to the field of data processing systems, and in particular, to the field of managing data processing systems. Still more particularly, the present invention relates to a system and method of optimizing processing of data on a data processing system.

2. Description of the Related Art

The BlueGene/L, a product of International Business Machines of Armonk, N.Y., is revolutionary, low-cost computer system that delivers extraordinary computing power for scientific simulations and programmatic work. BlueGene/L includes a collection (often numbering in the thousands) of compute or I/O nodes, where each compute node is a single application-specific integrated circuit (ASIC) with associated dynamic random-access memory (DRAM) memory chips. The ASIC integrates two 700 MHz PowerPC 440 embedded processors, each with a double-pipeline-double-precision Floating Point Unit (FPU), a cache sub-system with built-in DRAM controller and the logic to support multiple communication sub-systems.

Because the BlueGene/L incorporates thousands of processors, it is extremely difficult to get a simple view of where applications are running on the computer system and the level of resource utilization for a subset of compute nodes. Therefore, there is a need for a system and method for addressing the aforementioned limitations of the prior art.

### SUMMARY OF THE INVENTION

The present invention includes a method, system, and computer-usable medium for visually representing resource usage in a multi-node data processing system. According to a preferred embodiment of the present invention a graphical user interface (GUI) stored in system memory visually expresses the multi-node data processing system as a collection of cubes, where each cube among the collection of cubes represents at least one node within the multi-node data processing system. The GUI specifies a currently-running application to measure a level of resources utilized by the currently-running application. The GUI indicates a type of resource information to be displayed and display the indicated type of resource information related to the currently-running application utilizing the collection of cubes.

The above, as well as additional purposes, features, and advantages of the present invention will become apparent in the following detailed written description

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1 is a block diagram illustrating an exemplary multi-node data processing system in which a preferred embodiment of the present invention may be implemented;

FIGS. 2A-2B are pictorial representations of a graphical user interface (GUI) according to a preferred embodiment of the present invention;

FIG. 2C is a pictorial representation of a detailed information display in accordance with a preferred embodiment of the present invention;

FIG. 3 is a high-level logical flowchart illustrating an exemplary method of visually representing resource usage in a multi-node data processing system according to a preferred embodiment of the present invention.

### DETAILED DESCRIPTION OF AN ILLUSTRATIVE EMBODIMENT

The present invention includes a graphical user interface (GUI) that provides visual information on processor, memory, and network path resources for an application running on a multi-node data processing system. Once the application is invoked on the multi-node data processing system, the GUI maps the multi-node data processing system's topology as a three-dimensional object. The GUI may alternatively utilize other topologies, including, but not limited to, a one-dimensional mesh or a one-dimensional torus. The user may select parts of the graphical representation to obtain more information about where the application is running and how network resources are being utilized during application execution.

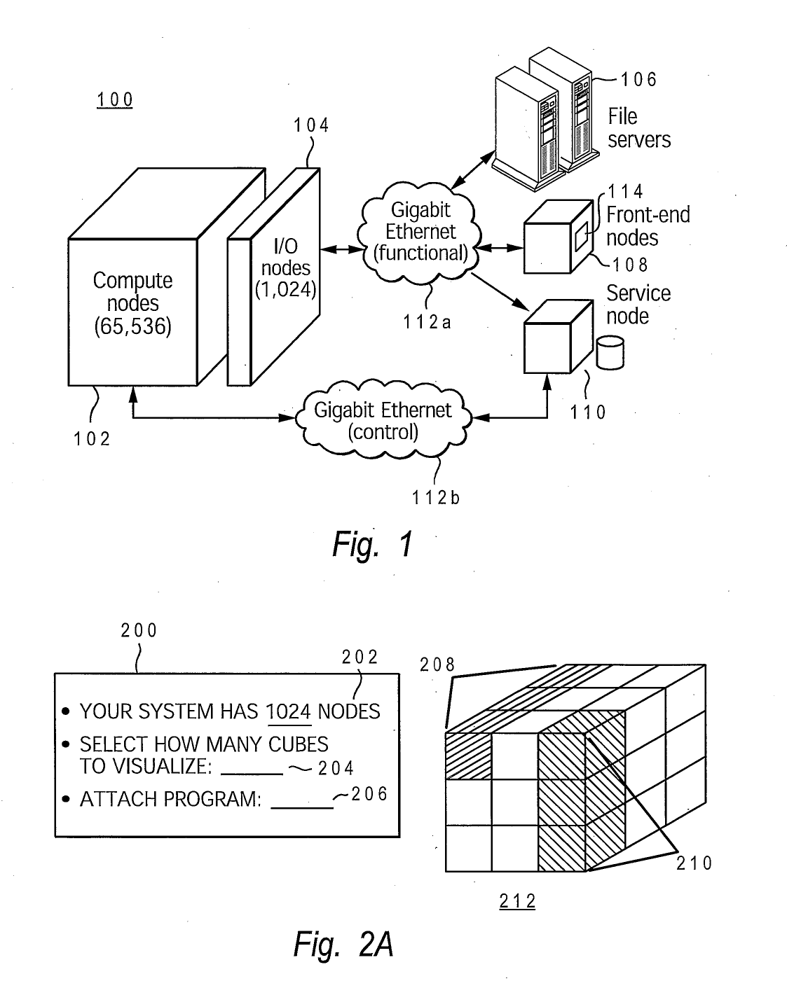

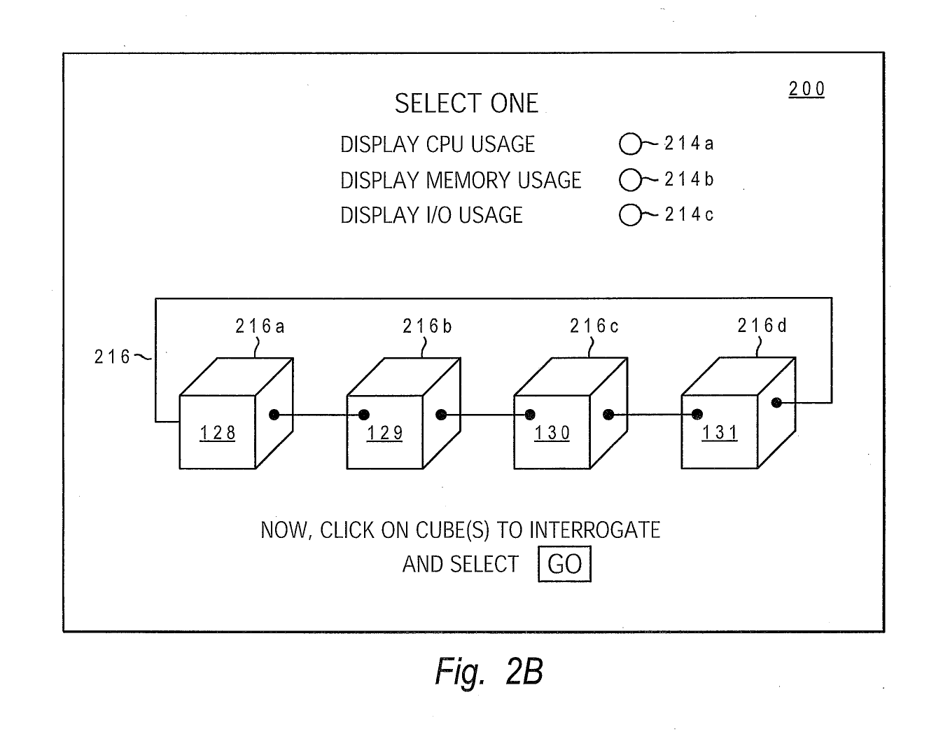

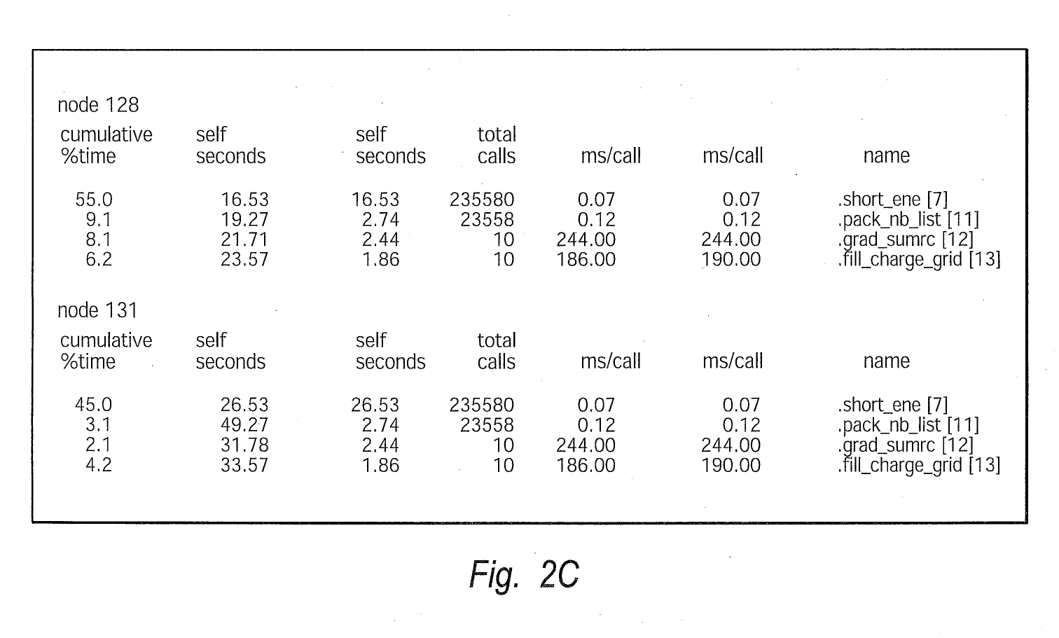

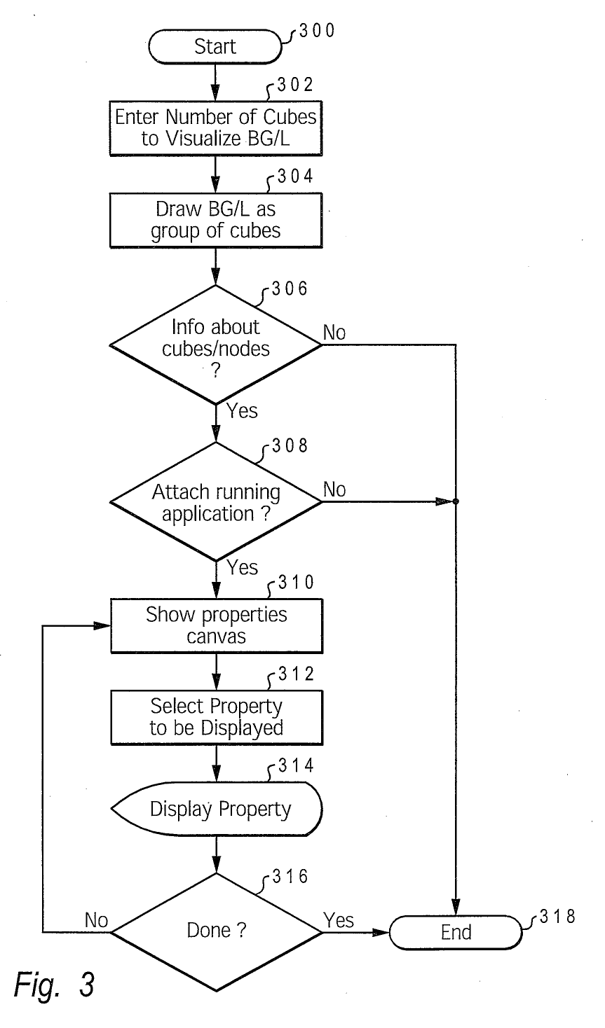

Referring now to the figures, and in particular, referring to FIG. 1, there is illustrated a block diagram depicting an exemplary multi-node data processing system 100 in which a preferred embodiment of the present invention may be implemented. As illustrated, multi-node data processing system 100 includes compute nodes 102, I/O nodes 104, file servers 106, front-end nodes 108, and service node 110. Gigabit Ethernet (functional) 112a couples compute nodes 102 to service node 110 (for control of the machine), front-end nodes 108 (where users compile, submit, and interact with their jobs), and parallel file servers 106. Service node 110 also connects to compute nodes 102 through Gigabit Ethernet (control) 112b that is utilized for direct manipulation of the hardware, as discussed herein in more detail. Front-end nodes 108 also include a system memory 114 for storing an operating system, user applications, and GUI 200, as discussed herein in more detail in conjunction with FIGS. 2 and 3.

Compute nodes 102, preferably implemented by 65,536 compute nodes, is preferably partitioned into 1,024 logical processing sets (“psets”). Each pset includes one I/O node running Linix and 64 compute nodes running a custom compute node kernel (CNK). Psets are not physical entities in the architecture, but are assembled logically from compute nodes 102 and I/O nodes 104 of a partition by assigning compute nodes to a particular I/O node. There is a certain degree of flexibility in assigning nodes to a pset, and their configuration is part of machine setup. In particular, alternative configurations are possible, with a ratio of I/O-to-compute nodes from 1:8 to 1:128. That is, psets can be as small as eight compute nodes and as large as 128 compute nodes (conditional upon appropriate hardware present).

FIG. 2A is a pictorial representation of a graphical user interface (GUI) 200 stored in system memory 114 in accordance with a preferred embodiment of the present invention. GUI 200 includes field 202, which indicates to the user the number of compute nodes in multi-node data processing system 100. Field 204 prompts the user to enter the number of cubes to visualize multi-node data processing system 100. Field 206 prompts the user to enter the name of the program the user desires to monitor. Within the system memory of service nodes 110, compute nodes 102 are visualized as a cube 212, with rows 208 and 210 representing the location of each of the application's processors mapping to the machine topology.

Once the user has selected the number of nodes to be utilized to visualize the system, GUI 200 transitions to the screen illustrated in FIG. 2B. FIG. 2B depicts GUI 200 with selection fields 214a-c, which enable the user to select the property (CPU, memory usage, I/O usage, etc.) that the user wants shown in GUI 200. After selected the desired property, the user clicks on the desired cubes for more detailed information on the resources represented by those cubes 216a-d. This process is discussed in more detail in conjunction with FIG. 3.

For example, assume that the user has selected cubes 216a and 216d for the display of more information in GUI 200. A more detailed information display of cubes 216a and 216d is illustrated in FIG. 2C.

FIG. 3 is a high-level logical flowchart illustrating an exemplary method of visually representing resource usage in a multi-node data processing system according to a preferred embodiment of the present invention. The process begins at step 300 and proceeds to step 302, which illustrates GUI 200 prompting the user to enter a number of cubes utilized to visualize multi-node data processing system 100. The process continues to step 304, which shows GUI 200 expressing multi-node data processing system 100 as a group of cubes (e.g., cubes 216a-d) or cube 212.

GUI 200 prompts the user to select at least one cube for more information on the resource represented by that cube, as depicted in step 306. If the user does not desire more information about the resources in multi-node data processing system 100, the process continues to step 318, which illustrates the process ending.

Returning to step 306, if the user desires more information about the resources in multi-node data processing system 100, GUI 200 prompts the user to enter the name of a currently-executing application on compute nodes 102, as illustrated in step 308. If the user does not enter the name of a currently-executing application, the process ends, as illustrated in step 318.

If the user enters the name of a currently-running application, the process proceeds to step 310, which shows GUI 200 illustrating a properties canvas, such as fields 214a-c. As previously discussed, fields 214a-c enables the user to select the properties to be monitored (e.g., CPU usage, memory usage, and I/O usage). The process continues to step 312, which depicts the user selecting a property to be displayed. In step 314, GUI 200 displays the selected property. The process continues to step 316, which illustrates GUI 200 determining if the process is complete. If the process is complete, the process ends, as illustrated in step 318. If the process is not complete, the process returns to step 310 and continues in an iterative fashion.

As discussed, the present invention includes a method, system, and computer-usable medium for visually representing resource usage in a multi-node data processing system. According to a preferred embodiment of the present invention a graphical user interface (GUI) stored in system memory visually expresses the multi-node data processing system as a collection of cubes, where each cube among the collection of cubes represents at least one node within the multi-node data processing system. The GUI specifies a currently-running application to measure a level of resources utilized by the currently-running application. The GUI indicates a type of resource information to be displayed and display the indicated type of resource information related to the currently-running application utilizing the collection of cubes. It should be understood that at least some aspects of the present invention may alternatively be implemented in a computer-usable medium that contains a program product. Programs defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to Random Access Memory (RAM), and communication media, such as computer and telephone networks including Ethernet, the Internet, wireless networks, and like network systems. It should be understood, therefore, that such signal-bearing media when carrying or encoding computer-readable instructions that direct method functions in the present invention represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention.

What is claimed is:

1. A computer-implementable method for visually representing resource usage in a multi-node data processing system, said method comprising:
visually expressing said multi-node data processing system as a plurality of cubes, wherein each cube among said plurality of cubes represents at least one node within said multi-node data processing system;
specifying a currently-running application on said multi-node data processing system to measure a level of resources utilized by said currently-running application;
indicating a type of resource information to be displayed; and
displaying said type of resource information related to said currently-running application utilizing said plurality of cubes.

2. The computer-implementable method according to claim 1, further comprising:
selecting at least one cube among said plurality of cubes; and
when said at least one cube is selected, displaying more detailed resource information associated with said at least one node represented by said at least one cube.

3. The computer-implementable method according to claim 1, wherein said resource information includes levels of processor, input/output, and memory resource usage.

4. The computer-implementable method according to claim 1, further comprising:
receiving a value representing a number of cubes desired to be utilized in said visually expressing said multi-node data processing system as said plurality of cubes.

5. A system for visually representing resource usage in a multi-node data processing system, said system comprising:
a plurality of nodes, which further include at least one processor;
a data bus coupled to said plurality of nodes; and
a computer-usable medium embodying computer program code, said computer-usable medium being coupled to said data bus, said computer program code comprising instructions executable by said at least one processor and configured for:
visually expressing said multi-node data processing system as a plurality of cubes, wherein each cube among said plurality of cubes represents at least one node within said multi-node data processing system;
specifying a currently-running application on said multi-node data processing system to measure a level of resources utilized by said currently-running application;
indicating a type of resource information to be displayed; and
displaying said type of resource information related to said currently-running application utilizing said plurality of cubes.

6. The system according to claim 5, wherein said instructions are further configured for:
selecting at least one cube among said plurality of cubes; and
when said at least one cube is selected, displaying more detailed resource information associated with said at least one node represented by said at least one cube.

7. The system according to claim 5, wherein said resource information includes levels of processor, input/output, and memory resource usage.

8. The system according to claim 5, wherein said instructions are farther configured for:
receiving a value representing a number of cubes desired to be utilized in said visually expressing said multi-node data processing system as said plurality of cubes.

9. A computer-usable medium embodying computer program code, said computer program code comprising computer-executable instructions configured for:
visually expressing said multi-node data processing system as a plurality of cubes, wherein each cube among said plurality of cubes represents at least one node within said multi-node data processing system;
specifying a currently-running application on said multi-node data processing system to measure a level of resources utilized by said currently-running application;
indicating a type of resource information to be displayed; and
displaying said type of resource information related to said currently-running application utilizing said plurality of cubes.

10. The computer-usable medium according to claim 9, wherein said embodied computer program code further comprises computer executable instructions configured for:
selecting at least one cube among said plurality of cubes; and
when said at least one cube is selected, displaying more detailed resource information associated with said at least one node represented by said at least one cube.

11. The computer-usable medium according to claim 9, wherein said resource information includes levels of processor, input/output, and memory resource usage.

12. The computer-usable medium according to claim 9, wherein said embodied computer program code farther comprises computer executable instructions configured for:
receiving a value representing a number of cubes desired to be utilized in said visually expressing said multi-node data processing system as said plurality of cubes.
